(19) United States
(12) Patent Application Publication
(10) Pub. No.: US 2004/0257435 A1
(43) Pub. Date: Dec. 23, 2004

(54) Method of tessellating a surface

(76) Inventor: Joseph DeWitt Clinton, West Chester, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/332,074

(22) PCT Filed: Jun. 13, 2001
(86) PCT No.: PCT/GB01/02593

(30) Foreign Application Priority Data
Jul. 3, 2000 (GB) 0016327.9

(51) Int. Cl. H04N 7/00

(52) U.S. Cl. 348/36; 348/38

(57) ABSTRACT

A method of tessellating a surface into a family of modular elements comprised of diamond shaped areas.

This invention relates to a method of tessellating a surface.

U.S. Pat. No. 1,616,736 discloses the first optical planetarium projection device for projecting images onto the internal surface of a sphere. The invention of the first planetarium projector was the beginning of a long line of projection devices for applying images onto a spherical surface. In the case of planetarium projectors where many single points of light were being projected and motion of the image across the sphere was accomplished by moving the projectors as a unit at the center of the sphere, the matching of adjacent projection images did not present a problem.

When the motion film industry introduced film projection onto the surface of the sphere, the location of a single lens projector at the sphere center solved the problem of having many projectors with edge overlapping images. The film size was also increased to the 70 mm film format in order to provide the necessary resolution not to degrade the image quality. The sphere was also tilted with respect to the viewer and limited to that of less than a hemisphere.

A single light source was sufficient for the needed light output for planetarium use as well as for film projection. However, with the introduction of video projection devices, a single projector usually cannot supply the necessary illumination for the image quality desired. Thus the problem of matching edges to give the appearance of a seamless image presented itself.

The prior art referred to above can be divided into the following types:

Direct front projection displays;

Direct rear projection displays;

Emissive surface visual display devices; and

Image transfer devices.

This prior art will now;be considered in more detail.

Direct Front Projection Display

Most direct front projection visual display systems using a spherical projection screen arrange a group of projectors inside of the sphere and project the image onto the screen. The imaging plane consists of a rectangular format. The rectangular image becomes distorted when projected into the spherical surface. The degree of distortion is dependent upon the placement of the projector with respect to the projection screen. In all cases, however, in order to completely cover the sphere a significant amount of image overlap must be tolerated. The image distortions may be corrected optically, geometrically through software, or electronically within the system. Masking and blending of overlap areas must also be done.

With small fields-of-view and careful planning, efficient configurations can be achieved. But, as the fields-of-view increase in both azimuth and elevation, the system becomes more complex and efficient image overlap is more difficult to achieve. The number of pixels on the image plane that become wasted increases as complexity increases. Reshaping the image to arrest distortions in the final projected image also becomes more complex. Uniformity of illumination, image contrast, geometrical correctness, and image resolution become more difficult to achieve using the typical gore/zone or longitude/latitude tessellation method of subdividing the sphere into projection areas of image coverage.

The 1923 Zeiss Optical Works projector disclosed in the above mentioned 1923 U.S. Pat. No. 1,616,736 was described by Henry Simon in his article “Design of the Zeiss Planetarium”, in the American Machinist magazine, Aug. 8, 1929 issue as utilising the broad idea of a hollow, semi-spherical projector body, bearing upon its surface a fixed-star pattern and illuminated by a powerful central lamp, and an adjacent co-axial cylindrical framework divided into a number of chambers for individual moving projectors to represent the sun, moon, and planets. By endowing such a body with proper motions, a correct moving picture of the heavens could be produced upon the interior of a large hemispherical dome. The plan for the projection of the fixed stars was developed on the hypothesis that instead of being spherical, the surface of the projection was an icosahedron or twenty-sided body * from which the twelve corners had been cut off. This produces a polyhedron bounded by twenty hexagons and twelve pentagons. Of these 32 fields, one half are served by sixteen projectors upon the carrier for the northern, firmament, and the other half by as many more projectors for the southern firmament. The sixteen projectors in each carrier are illuminated by a central lamp of 1,000 watts.

The sphere was tessellated into 32 facets composed of 12 pentagons and 20 hexagons in order to cover an entire sphere. For static images composed of several single light points on a black field, the pentagon and hexagon tessellation of the sphere proves to be very efficient. However, when moving images on bright backgrounds are projected through such a device, the mosaic pattern of tiles on the projection screen become a problem for providing a seamless image.

In U.S. Pat. No. 5,023,725 there is disclosed a method and apparatus for a dodecehedral imaging system. More specifically, there is disclosed a dodecahedral environmental photography and projection system based on a pentagonal format, designed for a modular compound camera and projector system aligned according to the dodecahedron, for the photography and projection of apparently continuous images across the interior surface of a dome or spherical theater. The use of a compound system provides better resolution than a single-camera system, and the use of a pentagonal picture as a standard shape allows complete coverage of a spherical surface, and greater use of the available lens image than existing rectangular formats.

Even though this was an improvement over earlier systems such for example as those disclosed in U.S. Pat. Nos. 1,616,736, 2,632,359 and 4,588,384, it has some serious drawbacks. The system is limited to twelve image planes for complete spherical coverage.

As pointed out in the second edition of Human Factors Design Handbook, McGraw-Hill, 1992, page 660, at the lowest intensity of light, the eye can see a line whose thickness subtends a visual angle of 10 minutes. At very high intensities, the eye can see a line subtending less than 1 second of visual angle.

The best present video display systems are capable of achieving a pixel array of 1040×1040. The number of modules needed to efficiently cover an entire sphere with a 1040×1040 pixel matrix display panel can be calculated thus:

The surface of a sphere=4π steradian

1 steradian=(180°/π)² square degrees

=3282.8063500011740 square degrees

4π steradian=41,252.961248419300 square degrees

and: 4π steradian≈148,510,660 square minutes

If each pixel=1 square minute then:

148,510,660 pixels are needed to cover a sphere

A 1040×1040 pixel matrix=1,081,600 pixels

Therefore:

≈137 panels would be needed for the entire sphere, assuming there is no waste of pixels in the system.

Most video displays are designed around a rectangular pixel format, 640×480,800×600,1024×768,1280×1040. A 1280×1040 pixel array has 1,331,200 pixels. In order to achieve the best resolution for a pentagonal panel 41% of the available pixels are not used.

With the twelve panels of the dodecahedron a one-minute resolution cannot be achieved. A pentagonal dodecahedron has 785,829 pixels per face for a 1280×1040 configuration or 9,429,948 pixels per sphere which give a 3.97-minute resolution at best. To further frustrate the issue there is additional waste due to image overlap for blending adjacent channels to give a seamless appearance across adjacent channel edges.

Most projection systems are considered acceptable if they are between 3 and 6 minutes resolution. Even though the pentagonal dodecahedron falls within the acceptable range, as demand pushes for higher and higher resolution, the pentagonal dodecahedron configuration will not be able to accommodate the demand.

Direct Rear Projection Displays

Rear or back projection visual systems have been in use for film projection displays for many years. They have been an effective way of presenting images onto flat screens under ambient light conditions. Back projection also has the advantage of removing the projectors from the space occupied by the observer, thus solving certain occultation problems. Many innovations have been made over the years that have improved the image quality with such systems.

One such invention is disclosed in U.S. Pat. No. 4,473,355 which relates to a spherical back-projection screen. A visual simulator has a display screen forming a vault. Back-projectors are arranged outside of the screen vault which is transparent to project the image, such as an environment image into the vault which holds a training cockpit for training pilots or tank commanders. The screen is made of a single layer of film or skin of plastic material having at least one projection field with a surface structure forming a Fresnel type collecting or converging lens having an optical axis pointing toward the cockpit.

In the U.S. Pat. No. 4,473,355, it is apparent from the description of the ‘projection fields’ that each field has a unique Fresnel type collecting lens having the characteristics of a gore/zone or longitude/latitude geometry, thus having a similar disadvantage to the previously described direct front projection screens.

In a similar manner, the imaging plane consists of a rectangular format. The rectangular image becomes distorted when projected in to the spherical surface. The degree of distortion is dependent upon the placement of the projector with respect to the projection screen. Also, in order to completely cover the sphere, a significant amount of image overlap must be tolerated. The image distortions must be corrected within the system. Further, masking and blending of overlap must also be done. The use of Fresnel type collecting lens helps solve some of the problems but not all.

As in the direct front projection system, with small fields-of-view and careful planning, efficient configurations can be achieved. However, as the fields-of-view increase in both azimuth and elevation, the system becomes more complex and efficient image overlap is more difficult to achieve. The number of pixels on the image plane that becomes wasted increases as complexity increases. Reshaping the image to arrest distortions in the final projected image also becomes more complex.

A projection system for providing a panoramic scene in all viewable directions is disclosed in U.S. Pat. No. 4,656,506. More specifically, there is disclosed a projection system which includes an image projection unit which projects a plurality of images by way of sets of mirrors onto associated areas of the screen assembly. The projection unit and the screen assembly cooperate in such a way to project a substantially continuous panoramic scene onto the screen assembly such that a viewer sees a respective portion of the scene in any viewable direction. The spherical portion is formed of four side segments and a top segment, all of spherical curvature. Being based on a spherical hexahedron, the system has the advantage that all four channels would have the same type of optical characteristics. However, it suffers from the same resolution problems mentioned previously.

Most rear or back projection systems suffer from the same problems. Efficiencies of image shaping are only achieved where the fields-of-view are limited in size and shape. This is usually to shallow elevation angles symmetrical to the equator of the sphere, thus reducing keystone effects in the projector image and severe overlapping of image areas. Alternatively, the number of projection channels is limited to the symmetry of the spherical hexahedron, thus limiting the system to six projection channels.

Emissive Surface Visual Display Devices

Emissive surface visual displays have been in use since the introduction of the cathode ray tube. A television set, an oscilloscope, and a liquid crystal display laptop computer are all examples of emissive surface display devices. It has been a goal of many developers to develop large-scale emissive surface displays for simulation, theater, entertainment, and other uses.

A common technique for large surface displays is to arrange an array of cathode ray tubes, liquid crystal displays devices or other emissive devices to form a “video wall” of the desired size. U.S. Pat. No. 5,130,794 illustrates the combining of several video walls to make up a hexahedron that surrounds the observer by preferably substantially spherical coverage. It divides a composite image into a plurality of image segments or sub-segments for display on individual displays of multiple video display assemblies. Such a multiple video display assembly preferably includes a closed structure having individual display units mounted in all viewable directions therein, with segments of the composite image displayed on respective display units to recreate the panoramic view gathered by the panoramic optical assembly.

The rectangular array of conventional video devices does not lend themselves well to a truly spherical surface. Therefore, most video wall type solutions have been limited to enclosing the viewing space with flat surfaces or at best cylindrical surfaces.

U.S. Pat. No. 5,151,802 discloses a truly spherical emissive surface device. The device is for forming images on a large surface and it comprises an active screen whose display surface is formed at least partly by juxtaposed cells each constituting the image-forming surface of a device for producing images, the cells being excited individually, and those not excited being dark.

As with the other systems previously described, if the gore/zone or longitude/latitude tessellation is used for locating individual cells on the sphere, modularity of the cell arrays becomes more and more difficult as more and more of the spherical surface is used. The triangular tessellation of the surface illustrated is a more efficient method. However, the cell addressability becomes more complex.

In a similar way as for the direct front projection systems and the rear projection systems, many of the problems of the spherical emissive surface display systems may be solved by the use of the teachings of the present invention. The addressability of the modular components of a diamond shaped tessellation element retains the characteristics common in square or rectangular forms. The number of different types of modular elements is reduced to a minimum, yet may be applied to unlimited size displays.

Image Transfer Devices

When not directly viewing an emissive display device, the image has been transferred to a display surface and the observer will view the image transferred to that surface. The surface may be in the form of a direct back projection surface, or a direct front projection surface or the retina of the eye itself. Traditionally lenses are used to transfer the image from the emissive image plane to the screen. However, in recent years, direct back projection display systems have begun to experiment with transferring the image through optical-wave-guides to the display-viewing surface. European Patent No. 275,061 discloses a signboard for displaying optical images that uses such a technique. European Patent No. 324,142 discloses similar light guide type display apparatus. Neither of these two European patents considers arraying their systems onto a spherical surface.

However, part of U.S. Pat. No. 5,381,502 describes a flat or curved thin optical display panel that is specifically for a spherical projection surface. The system has extreme limitations for large spherical surface areas. It would be difficult to construct an entire sphere from such panels.

It is an aim of the present invention to provide an efficient solution to tessellating the surface of a sphere into modular elements, thus reducing the edge-blending problem to a minimum. The present invention also aims to provide a method for maintaining quality resolution, uniformity of illumination, and minimum distortion, with a reduced complexity of the visual system.

Accordingly, the present invention provides a method of tessellating a surface into a family of modular elements comprised of diamond shaped areas.

Preferably, the diamond shaped areas are approximately equal in size to each other.

Where the surface is the surface of a sphere, the family of tessellation may follow a {p,q⁺}_{b,c} symmetry group

Where: p=the shape of spherical polygon of the parent, ie. 3 is a spherical triangle.

And: q=the number of polygons arranged around the vertex of the spherical polygon.

And: b and c are counters along the edges of further triangular subdivisions of the parent spherical polygon following a path from one vertex to an adjacent vertex.

And: The number of subdivisions of the parent spherical polygon equals its frequency.

Where: Frequency(v)=b+c

This family of spherical tessellations may be divided into Classes where:

Class I: b>0 and c=0 or b=0 and c>0

Class II: b=c

Class III: b>c or c>b and the lesser≠0 an enantiomorphic condition exists where the b and c counters are exchanged.

The parent spherical polygon need not be an equilateral triangle. The parent spherical tessellation need not be limited to regular polyhedra. The method of tessellation may be applied to simple plane surfaces. The method of tessellation may be applied to simple curved surfaces. The method of tessellation may be applied to compound curved surfaces.

In the case where the tessellation is based on the symmetry group {p,q⁺}_{b,c} then the following topological conditions hold true:

For the {3,3+} symmetry group

The number of vertices=2T+2

The number of faces=4T

The number of edges=6T

Where: T=b²+cb+c² And: T must be divisible by 3 for the diamond face family.

For the {3,4+} symmetry group

The number of vertices=4T+2

The number of faces=8T

The number of edges=12T

Where: T=b²+cb+c² And: T must be divisible by 3 for the diamond face family.

For the {3,5+} symmetry group

The number of vertices=10T+2

The number of faces=20T

The number of edges=30T

Where: T=b²+cb+c² And: T must be divisible by 3 for the diamond face family.

Similar conditions hold true for other spherical polyhedra.

Each member of a family may be further subdivided according to the above mentioned principles. Alternatively, members of a family may be further subdivided into rows and columns of diamond shaped cells. Each cell may be generated from geodesic arcs passing through opposite edge subdivisions of the parent tessellation diamond module to construct the side of each row. Great circle arcs may pass through opposite edge subdivisions of the parent tessellation diamond module to construct the side of each column. The combination of row arcs and column arcs may describe the diamond shaped cell of further subdivisions of the parent module.

The number of new cells (f) for a parent spherical tessellation diamond module may be determined by v² where: v=the frequency of subdivision of the edge of parent spherical tessellation diamond module.

And: Fₙ=Fₒ*f

Where: Fₙ=the number of new faces of the desired spherical tessellation.

Fₒ=the number of old faces of the parent spherical tessellation.

f=the number of new cells for a parent spherical tessellation diamond module.

The method of the invention may be used to produce a family of structures composed of diamond shaped modules. Thus, for example, the family of structures may be a family of front projection screens composed of diamond shaped modules, or a family of back projection screens composed of diamond shaped modules.

The method of the invention may also be used to produce a family of structural support frames composed of diamond shaped modules.

The diamond modules and/or cells may be composed of but not limited to emissive surface display panels. Each panel may be configured for viewing from either the concave or convex side.

The display device assembly is not limited but can be configured to provide a seamless display system. The display panels may be configured for direct or indirect viewing. The display device may be composed of multiple elements.

The pixel layout for the emissive panels may be configured as per the principles set forth above. The emissive display panels can be identified as individual display channels using any number of conventional display architectural methods. The addressability at the pixel level for each channel may be treated in a conventional manner. Standard display architecture may be used throughout the system. The display panel will usually conform in size and shape to the diamond described by the surface tessellation.

The method of the invention may be used to produce the following products.

A display device composed of emissive display panels, held in place with a support frame disallowing direct contact with adjacent panels.

A seamless display device with an image expander that transfers the image a short distance from the emissive surface to a butt seam viewing surface.

An image expander made up of a series of close packed optical fibers that will optically transfer the image from a separated panel configuration to an apparent seamless viewing surface.

An image expander that can accommodate but is not limited to the transfer of an image from a flat emissive display surface to a curved viewing surface.

A display device using all or a combination of the above mentioned principles and applied to a head mounted display.

An image transfer device that transfers an image from an emissive display device to a viewing surface.

An image transfer device that transfers an image from the real world to a charged coupled device.

A projector consisting of one or multiple channels.

A projector assembly consisting of but not limited to an arrangement of lenses, a lens support device arranged as a pattern of {p,q}_{b,c} modules, or modular cells or a combination of each type, emissive display panels in an associated concentric diamond configuration, and their associated electronic hardware located internally and externally to the projector assembly.

A projector assembly consisting of but not limited to an arrangement of lenses, a lens support device arranged as a pattern of {p,q}_{b,c} modules, or modular cells or a combination of each type, emissive display panels in an associated flat diamond configuration, and their associated electronic hardware located internally and externally to the projector assembly.

A projector assembly consisting of but not limited to an arrangement of lenses, a lens support device arranged as a pattern of {p,q}_{b,c} modules, or modular cells or a combination of each type, fiber optical image transfer reshaping optical elements, emissive display panels in an associated conventional flat rectangular or square configuration, and their associated electronic hardware located internally and externally to the projector assembly.

A fiber optical image reshaping transfer optic for transferring an image from rectangular or square shapes to a diamond shape without loss in pixel column and row array.

A pupil forming visual display device comprised of a projector along with an imaging device which is located at one of the focus points of an ellipsoidal collimating mirror and the observer's eye which is located at the other. The image is transferred from the emissive surface display device through the transfer lenses to the collimating mirror surface and then reflected into the observer's eye. This thus reforms the image on the retina of the eye and appears as a continuous panoramic view of the images being projected.

A direct projection visual display device comprised of a modular projector support structure, an array of projectors, and a back projection screen that have been combined according to the above mentioned principles.

Embodiments of the invention will now be described solely by way of example and with reference to the accompanying drawings in which:

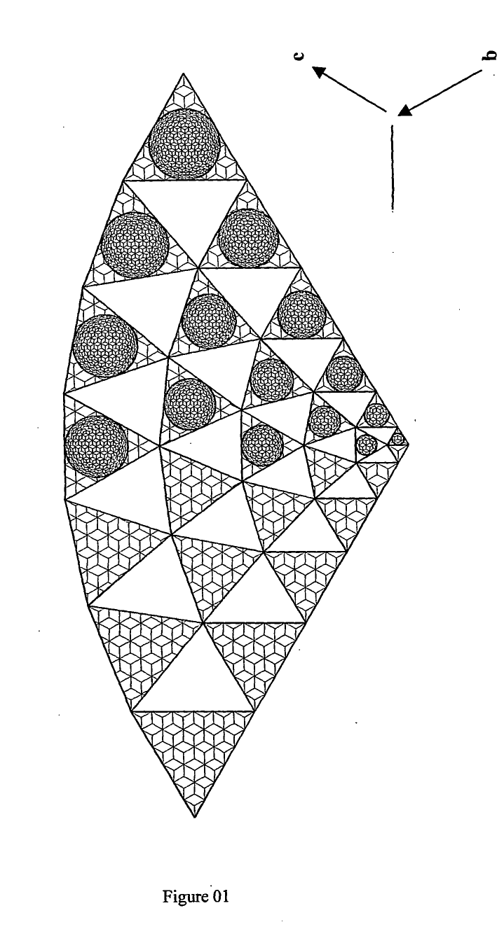

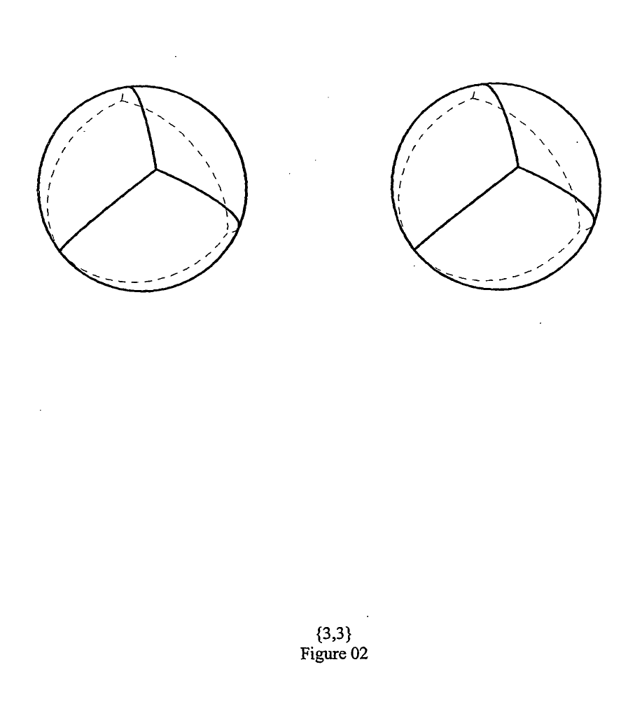

FIGS. 1-29 illustrate various aspects of the invention.

Referring to the drawings, FIG. 1 illustrates a family of spherical tessellation based on the {3,5+} symmetry group and having diamond shaped tessellation modules.

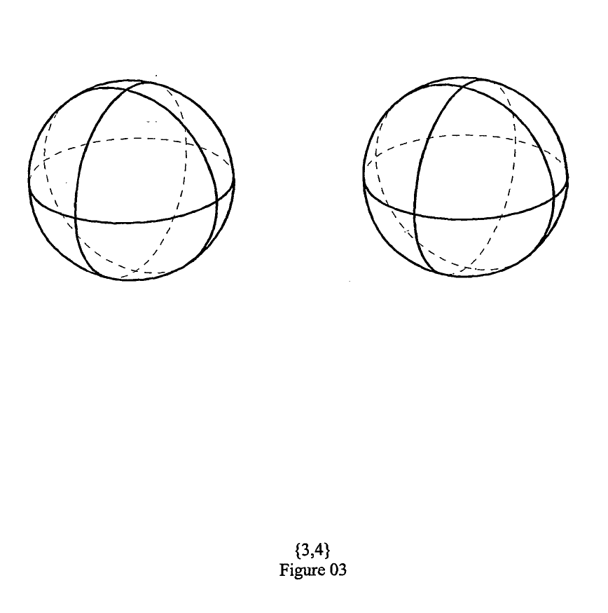

FIG. 2 illustrates parent spherical tessellation for the {3,3+} symmetry.

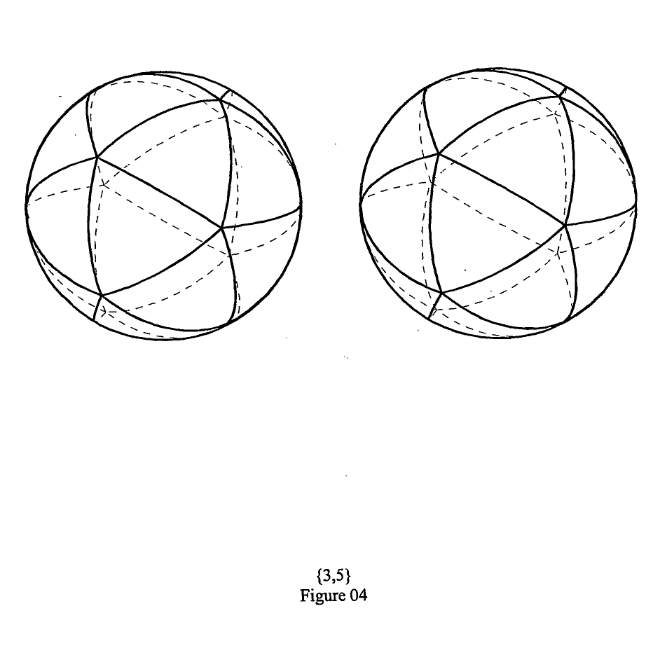

FIG. 3 illustrates parent spherical tessellation for the {3,4+} symmetry.

FIG. 4 illustrates parent spherical tessellation for the {3,5+} symmetry.

The parent spherical triangle need not be equilateral and the parent spherical tessellation need not be limited to those illustrated here. However, the parent spherical tessellation composed of equilateral spherical triangles tends to have the best uniformity of symmetry desirable for the applications disclosed in this invention.

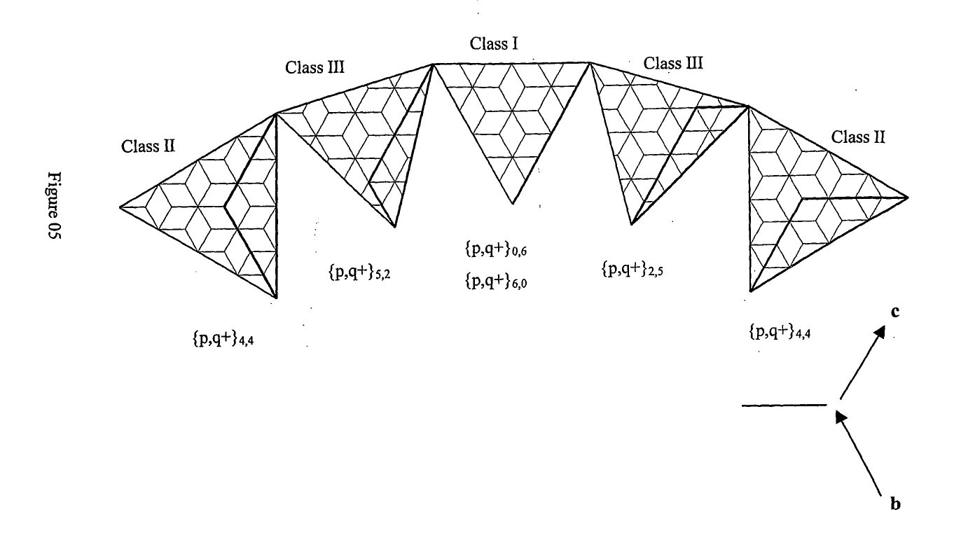

FIG. 5 illustrates the method for subdividing the parent spherical triangle into modular elements following the path of the b,c counters to define the Class and frequency of the spherical tessellation to be calculated.

If the tessellation is based on the symmetry group {p,q+}_{b,c} then the following topological conditions hold true:

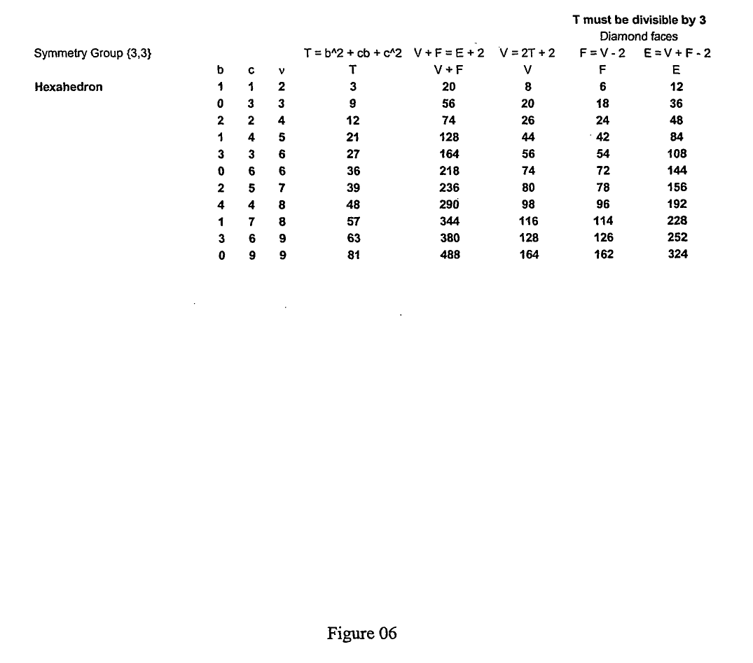

For the {3,3+} symmetry group (FIG. 6)

The number of vertices=2T+2

The number of faces=4T

The number of edges=6T

Where: T=b²+cb+c² And: T must be divisible by 3 for the diamond face family.

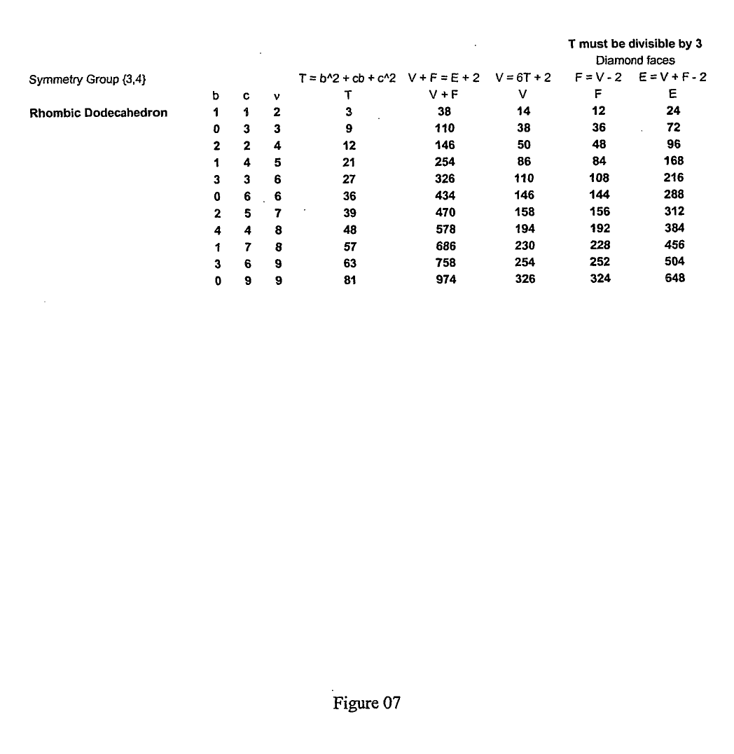

For the {3,4+} symmetry group (FIG. 7)

The number of vertices=4T+2

The number of faces=8T

The number of edges=12T

Where: T=b²+cb+c² And: T must be divisible by 3 for the diamond face family.

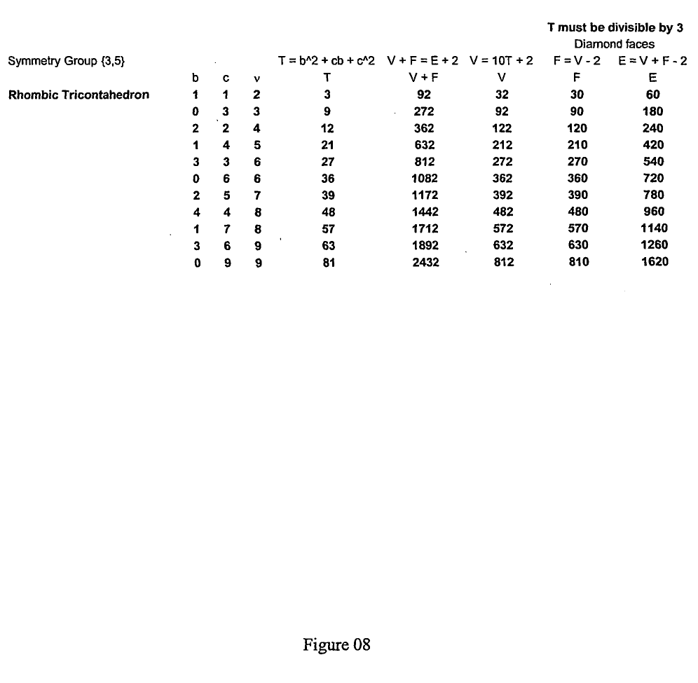

For the {3,5+} symmetry group (FIG. 8)

The number of vertices=10T+2

The number of faces=20T

The number of edges 30T

Where: T=b²+cb+c² And: T must be divisible by 3 for the diamond face family.

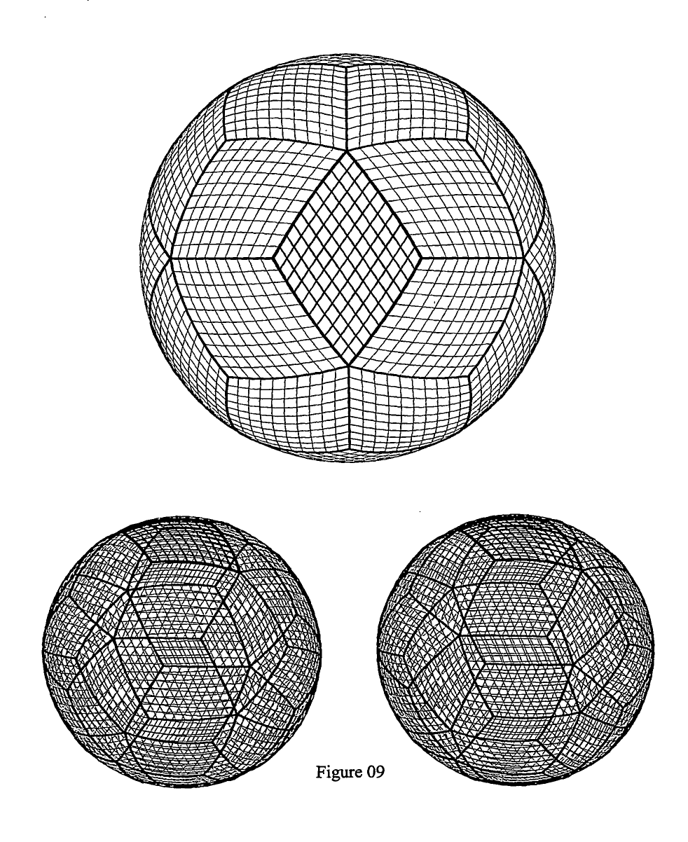

Each member of a family may be further subdivided according to the principles previously illustrated (FIG. 1) or may be subdivided into rows and columns as illustrated in FIG. 9. Great circle arcs passing through opposite edge subdivisions of the parent spherical tessellation diamond module generate each row. Similarly, great circle arcs passing through opposite edge subdivisions of the parent spherical tessellation diamond module generate each column. The combination of rows and columns describe the diamond shaped cell of further subdivision of the parent module.

The number of new cells (f) for a parent spherical tessellation diamond module is determined by v² where v=the frequency of subdivision of the edge of parent spherical tessellation diamond module.

Therefore: Fₙ=Fₒ*f

Where: Fₙ=the number of new faces of the desired spherical tessellation.

Fₒ=the number of old faces of the parent spherical tessellation.

f=the number of new cells for a parent spherical tessellation diamond module.

The method of subdivision just disclosed may be applied any number of problems associated with the tessellation of a surface into multiple elements. Several applications within the field of visual simulation systems will be described. However, the method of subdivision disclosed is not limited to those applications included here.

Structural Application as a Visual Display Screen

In the case of most spherical direct front or rear projection surfaces, they are assembled using many structural sections. These sections have been fabricated as gore/zone segments of the sphere. If the projection screen has a large radius, the screen will be made up from several different types of panels, each being slightly different in shape. This is necessary to keep the individual structural elements within the size limits for the manufacturing methods being used. The gore-zone method of subdividing the surface of a sphere into smaller areas is an inefficient method. As long as the screen is confined to a single zone within the limits of the method of fabrication, the number of different panel shapes remains small. However, as the zone of the sphere is increased, the number of different panel shapes is also increased.

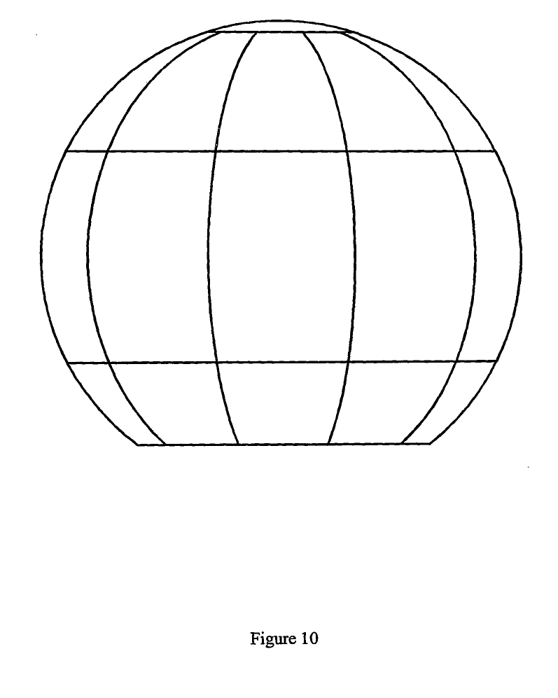

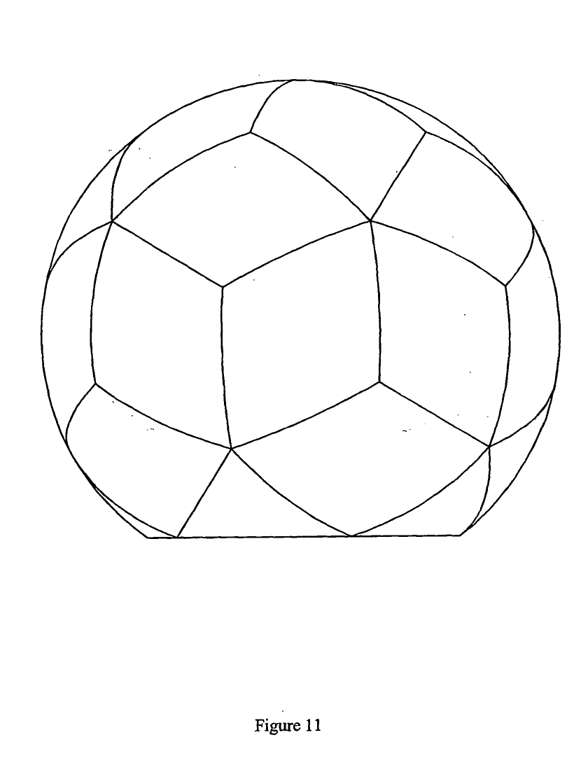

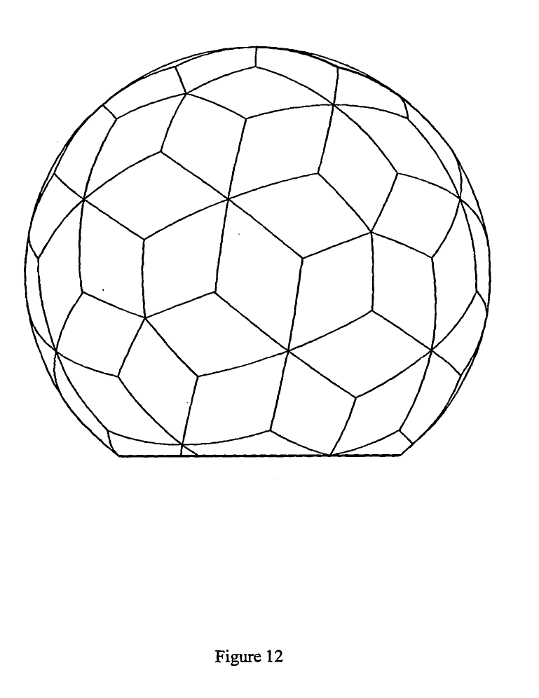

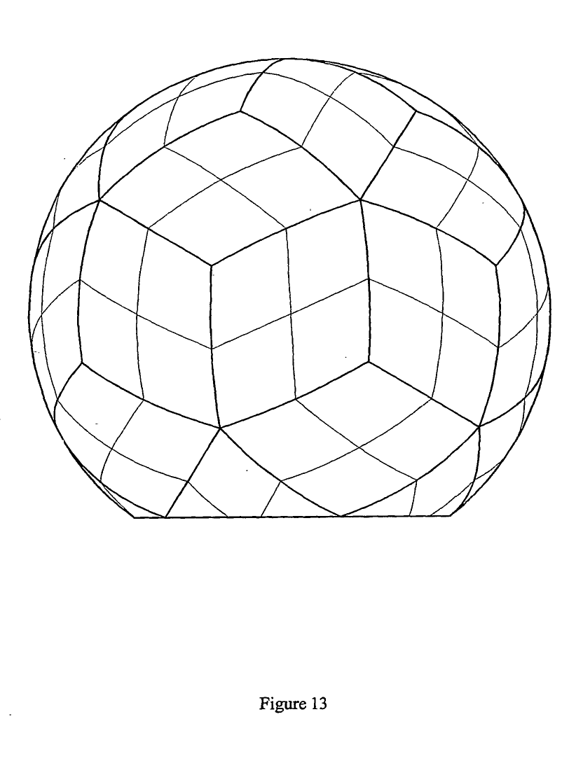

The method of subdivision disclosed in this invention reduces the number of different type panels to a minimum, thus reducing tooling and fabrication costs. FIGS. 10 and 11 illustrate a comparison between a gore/zone system and one of like size using the method disclosed in this invention. Each division about the equator in azimuth is equal to 36°. The limit of angular extent of the long axis for a panel is 53.14°. As illustrated in these two Figures, the gore/zone solution requires three basics types of panels while the method disclosed here requires one. Unique panels due to truncation have not been considered as separate types since they are a trimmed version of a standard panel.

FIG. 12 illustrates a further subdivision in the family of {p,q+}_{b,c} spherical tessellation. The [3,5+}_{0,3} spherical tessellation has 2 types of panels with a difference in surface area being less than 13%. Whereas its counterpart gore/zone system would have 3 panel types with as much as a 71% difference in surface area between its largest and smallest panel.

FIG. 13 illustrates a further subdivision of a {3,5+}_{1,1} spherical tessellation using the cell subdivision method. Each edge is divided into a 2 v subdivision thus creating 4 new cells per tessellation module of the ±3,5+}_{1,1} spherical tessellation. The 2 v subdivision of the {3,5+}_{0,3} spherical tessellation has 2 types of panels with a difference in surface area being less than 2%. In contrast, its counterpart gore/zone system would have 4 panel types with as much as a 61% difference in surface area between its largest and smallest panel.

Similar characteristics to those illustrated are exhibited for higher order subdivisions of both the {p,q+}_{b,c} family of tessellation and the cell subdivision family of tessellation. If additional structural support is required beyond the necessary screen panel, both systems lend themselves to a fully triangulated structural stiffening frame. The structural efficiency of such a frame is also better than those used in the traditional gore/zone method. The system disclosed in this invention allows for a more structurally efficient weight saving projection screen. This is especially useful for systems mounted on motion platforms and must behave efficiently under dynamic load conditions. Common methods of fabrication, structural interfaces, and manufacturing techniques, along with the use of common materials may also be used in the manufacture of the system. However, considerable savings in weight, use of materials, and manufacturing costs should be expected with the system described herein.

An Emissive Surface Display Device Application

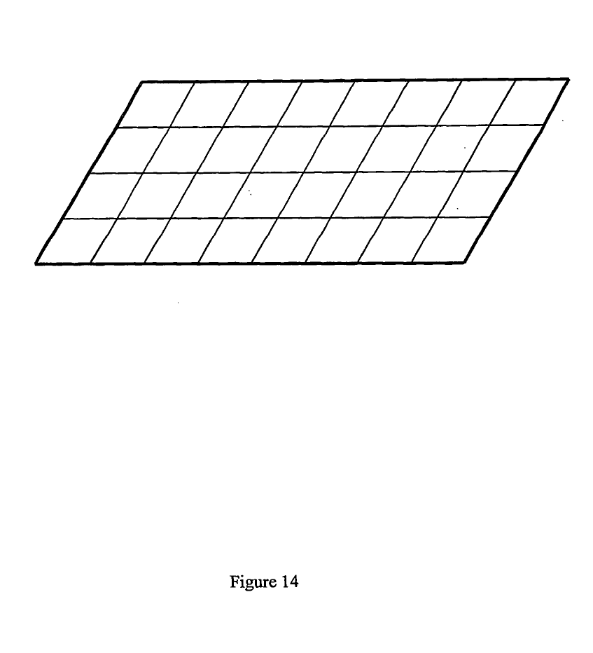

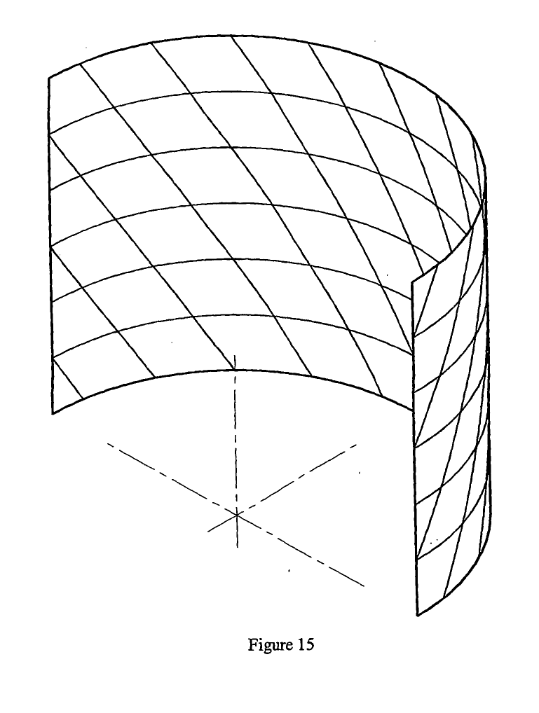

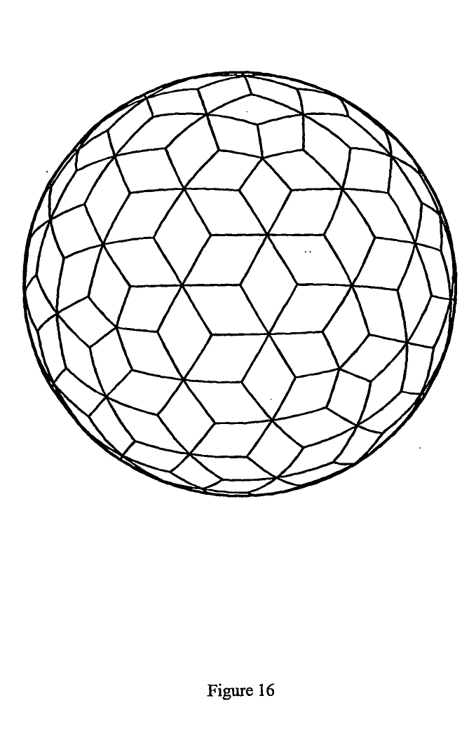

The subdivision modules in the family of {p,q+}_{b,c} tessellation can be thought of as IG channels instead of projection surface panels. In this way the diamond shape is a skewed square or rectangle similar to an emissive flat panel display device. FIGS. 14, 15 and 16 illustrate three possible configurations for arraying a series of liquid crystal display panels as a flat panel display, cylindrical display, and a spherical display respectively. The channels can be identified as individual display channels using any number of conventional display architectural methods. Also, the addressability at the pixel level for each channel is treated in the conventional manner. Therefore, standard display architecture may be used throughout the system, with the exception of the display panel itself. The display panel must conform in size and shape to the diamond described by the surface tessellation. For a large flat surface display or a large surface cylindrical surface display, using the cell subdivision approach, the system has the advantage that all display panels can be identical regardless of the display wall size, or radius in the case of the cylinder. For the spherical case, all panel types are the same as those described previously for spherical direct front and rear projection screens using either case; the {p,q+}_{b,c} method or the cell subdivision methods.

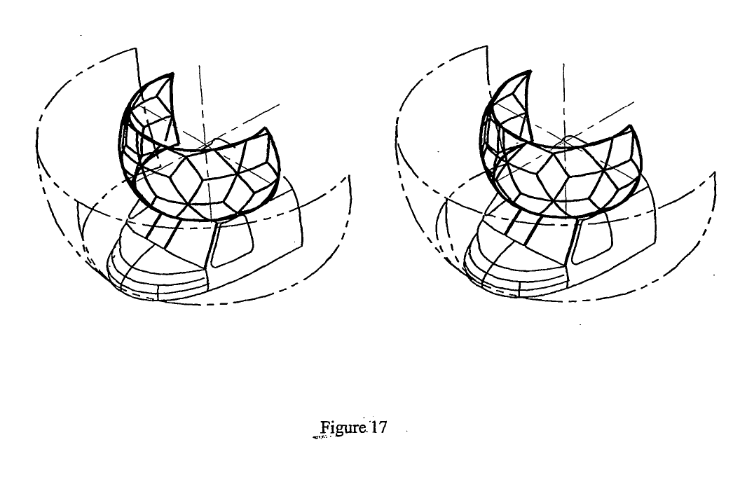

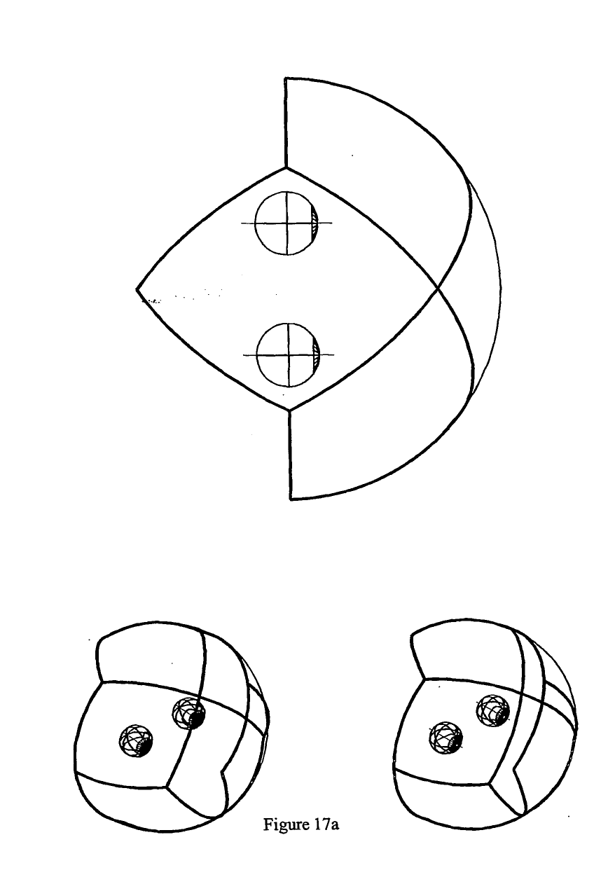

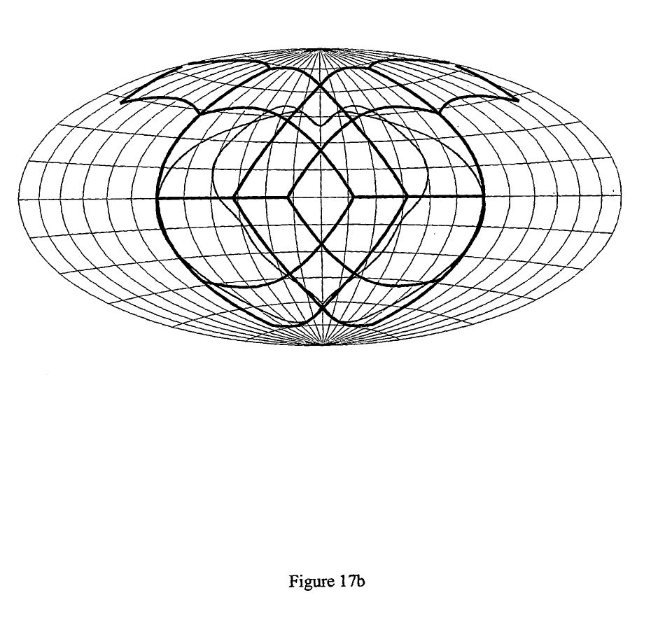

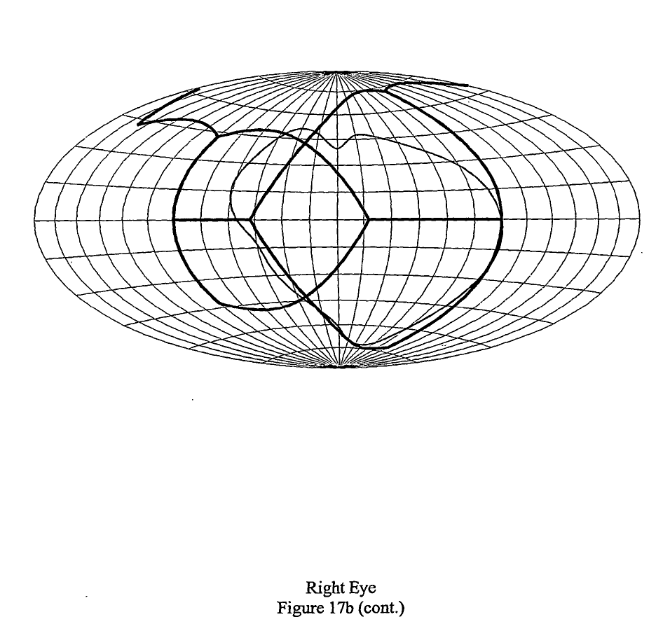

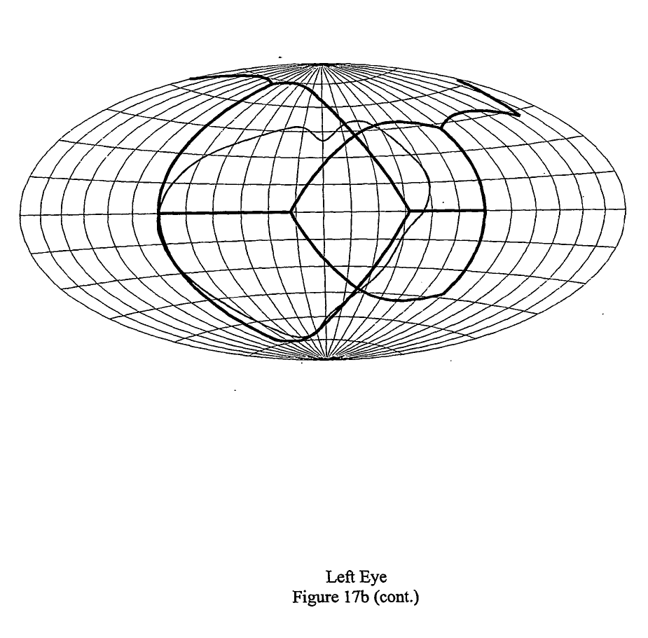

Any of the applications illustrated in FIGS. 14, 15 and 16, can have their display panels configured such that they may be viewed from either the concave side or the convex side of the display device. They may also be configured for direct viewing or indirect viewing, such as part of a collimated display where the display panels are viewed through a mirror arrangement as shown in FIG. 17.

A direct viewing of the concave surface of a display device using the {3,5+}_{1,1} symmetry group is illustrated in FIG. 17a as a head mounted display. The display consists of five to six emissive display channels arranged so that the center of curvature is mid way between the two eyes, and placed back from the mid-eye plane. The panels are arranged so that the field of view of the eyes are completely within the field of view of the visual display panels as illustrated in FIG. 17b.

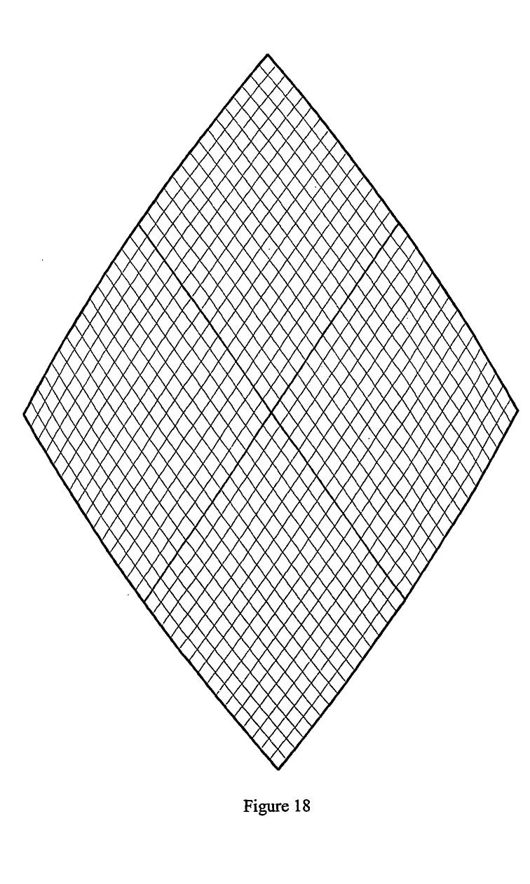

FIG. 18 illustrates the cell pattern for a typical pixel layout for a display panel. For simplicity a course array is shown in this figure. However, for a practical display panel, a 1024×1024 array might be chosen. The display panels should be configured such that they may be butted together to provide a seamless display. This may be accomplished by building in an image expander, an image transfer device, or an image-reshaping device as part of the support hardware for the emissive surface display panel.

Image Expander

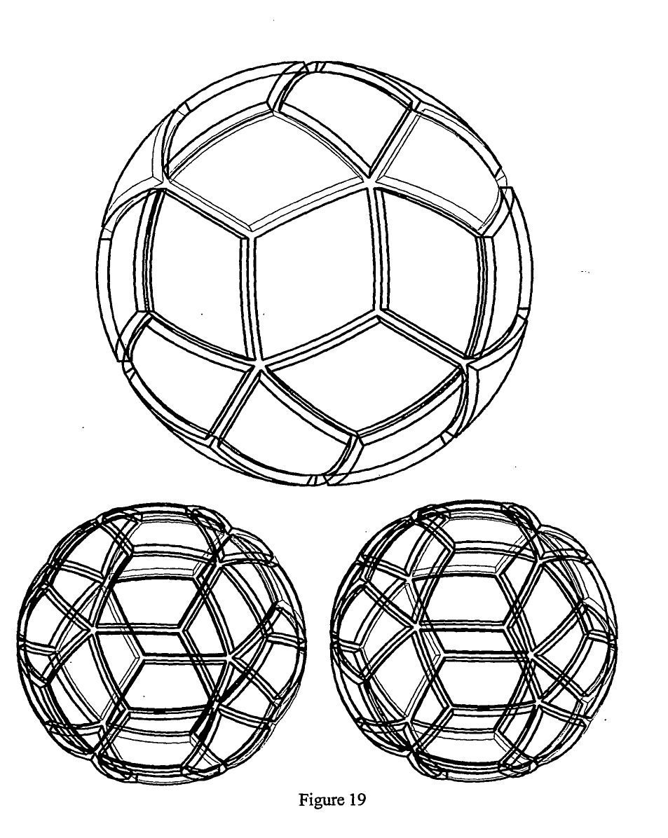

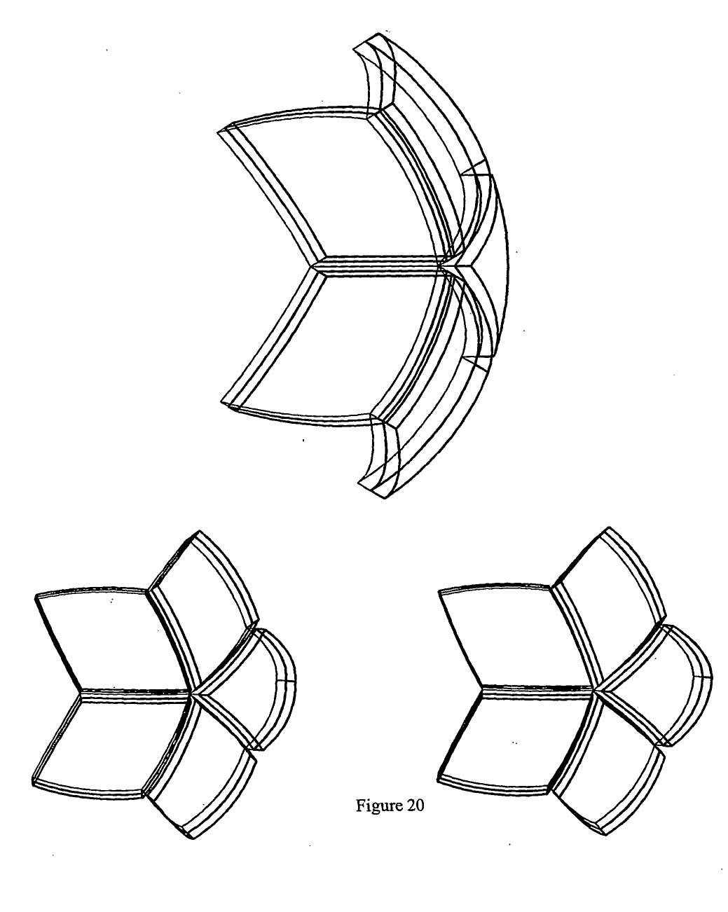

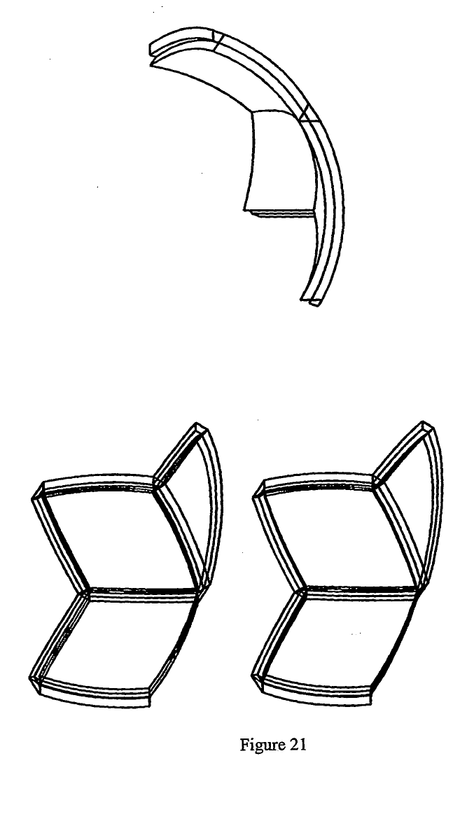

FIG. 19 shows a spherical visual device consisting of a mosaic of emissive surface display panels. The device is configured to be viewed from the concave side. Alternatively, it could have been configured for viewing from the convex side. Each panel is held in place with a support frame disallowing a direct butting of adjacent panels. Thus a seamless display surface would appear to be unable to be achieved. FIG. 20 shows a cluster of five adjacent panels typical of those illustrated in FIG. 19. It includes a support frame for the display panels, the display panels, and an image expander that transfers the image a short distance from the emissive surface of the display panels of the concave viewing surface. The image expander will accommodate a butting of the viewing surface panels thus giving a seamless display surface for the displayed image. The image expander is made-up of a series of close packed optical fibres that will optically transfer the image. FIG. 21 gives a cross section taken through the cluster of panels shown in FIG. 20. It further clarifies the location of the image expander, the frame, and the display panel. Even though the ideal configuration of a compound shape display panel is illustrated here, it could be a cylindrical or flat display panel. The image expander could be configured to accommodate the difference.

Image Transfer

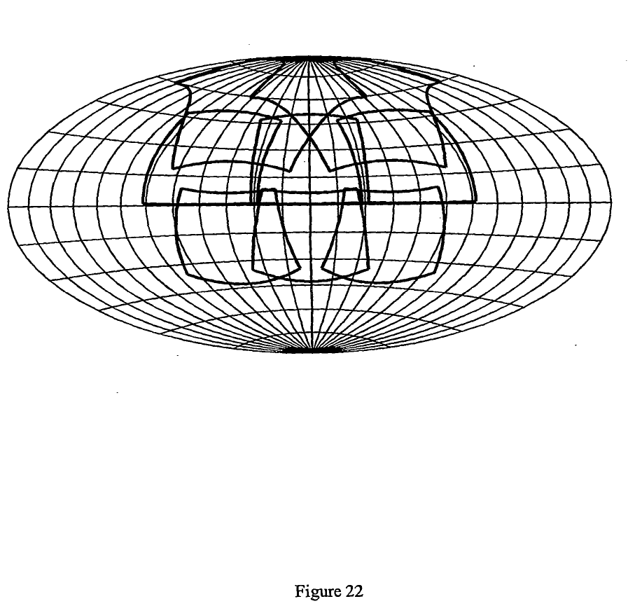

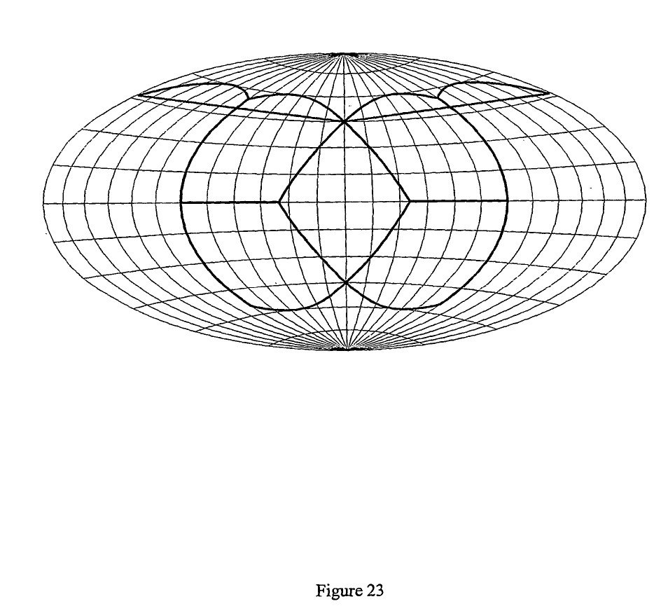

Lenses have long been known for their abilities to transfer images from one location to another. When used in a direct front projection display of the conventional type, they are generally transferring a rectangular image from an emissive surface to a spherically curved surface. FIG. 22 is an Aitoff plot of a spherical mapping of the logical display planes of a typical 8-channel front projection system. Note the inefficiencies of the channel overlap areas using the conventional projection system when the emissive surface is a rectangular format. The similar Aitoff plot of logical display planes in FIG. 23 illustrates the efficient use of the entire emissive surface when the channels are arranged and it is shaped as disclosed herein. Also, it may be noted the same area of coverage may be obtained with a 6-channel system with no loss in image quality.

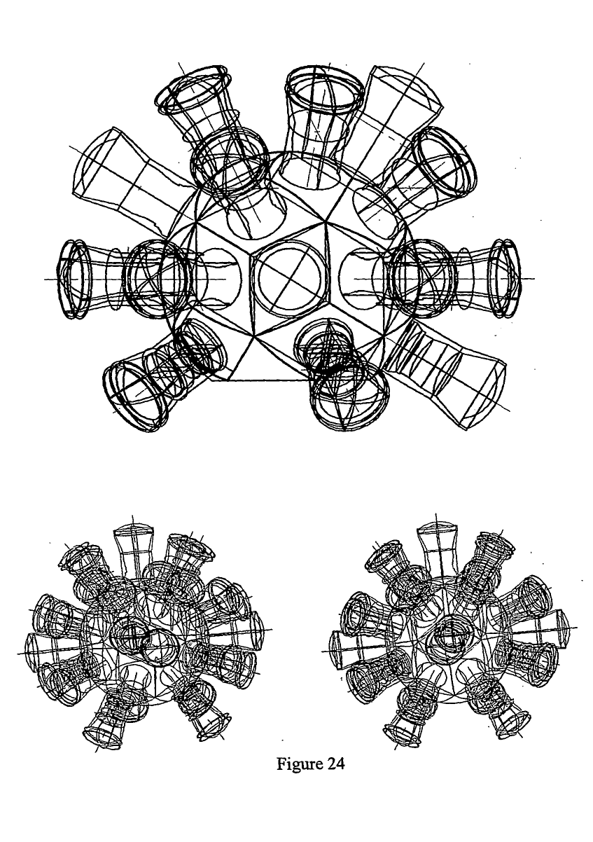

By mounting a group of lenses using the {p,q+}_{b,c} pattern grouping or the cell pattern grouping as disclosed earlier so that the lens optical axis lies perpendicular to the diamond shape face and passes through its center, a projector may be constructed to transfer an image from an emissive surface to a projection surface. The projector may consist of one channel or many channels depending on the quality of image desired for the system being designed. FIG. 24 illustrates a clustered lens projector that would cover more than a hemisphere. The projector assembly consists of an arrangement of lenses, a lens support device arranged as a pattern of {p,q}_{b,c} modules, the emissive cells and their associated electronic hardware located internally and externally to the projector assembly.

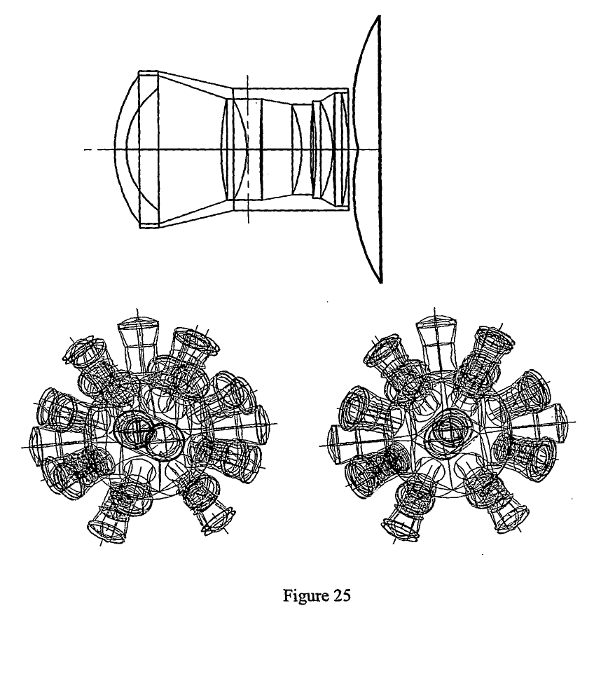

FIG. 25 illustrates a typical solution for the lens assembly, spherical diamond attachment and support module, and the diamond shaped emissive surface as illustrated in FIG. 24. The emissive surface could be configured as a spherical, cylindrical or planar surface for any of the applications mentioned earlier in this disclosure. The ideal case would be for it to take on a concentric shape of the surface being projected onto, with the projector being located at the center of the surface curvature. In the case of back projection, ideally the projector should be located on the axis passing through the center of surface curvature. However, the system may be located off axis and mapping corrections done for correcting the projected image geometry.

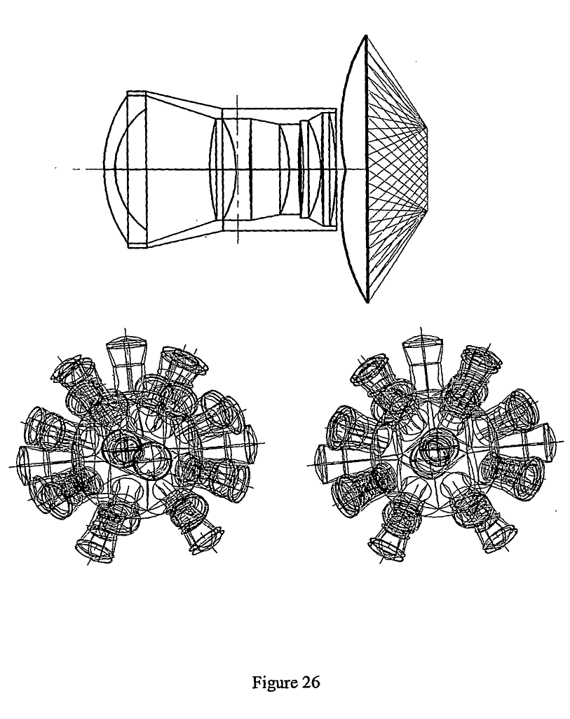

In the case where it is not economically feasible to manufacture a curved and/or diamond shaped emissive surface, a planar emissive surface may be used. However, an image reshaping optic must normally be placed in the optical transfer train. FIG. 26 illustrates such an assembly. The lens assembly, spherical diamond attachment and support module, and a diamond shaped image transfer surface are illustrated. Also shown is the fiber optical image reshaping transfer optic and the rectangular or square emissive surface. A square emissive surface is the ideal shape since the diamond edge lengths are nearly equal in length.

The emissive surfaces described could be replaced with a charged coupled device and the system would behave as a camera. In this configuration, the images being projected through a like device would not require corrections for distortion.

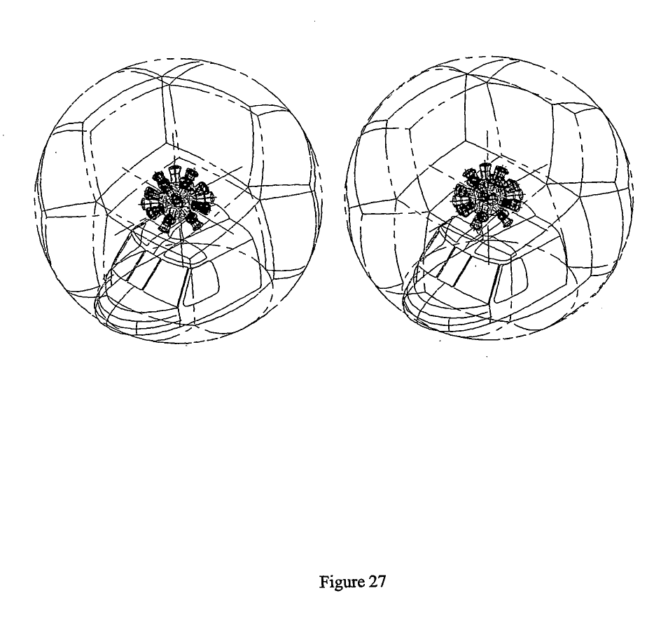

FIG. 27 illustrates a possible application of a pupil forming image transfer system using the teaching of this invention. The system illustrated here uses the {p,q}_{b,c} arrangement of polyhedral tessellation modules for the mirror, image transfer lenses, and the emissive surface display elements. The basic elements of the system are:

an ellipsoidal collimating mirror composed of diamond shaped front surfaced mirror cells arranged to match the arrangement of projector transfer lenses;

the image projector comprised of the elements described in the previous paragraphs of this section of the description;

the emissive surface display device; and

the retina of the observer's eye.

The centre of the projector along with the imaging devices are located at one of the focus points of the ellipsoidal mirror, and the observer's eye is located at the other. The image is transferred from the emissive surface display device through the transfer lenses to the collimating mirror surface and then reflected into the observer's eye. The image is reformed on the retina of the eye and appears as a continuous panoramic view of the images being projected.

Combined Elements

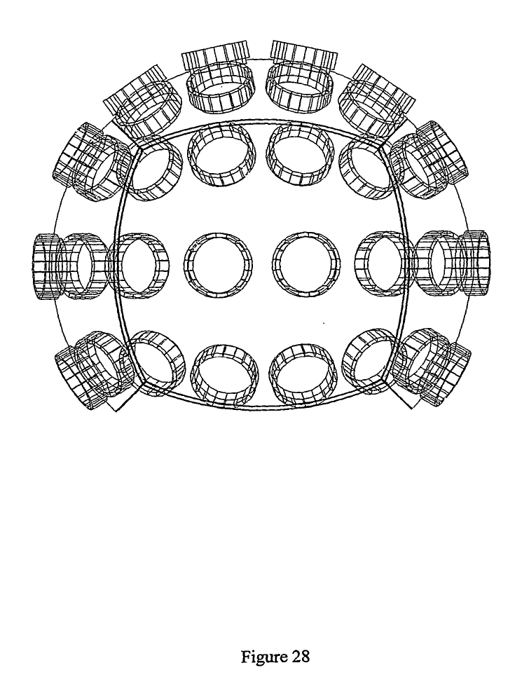

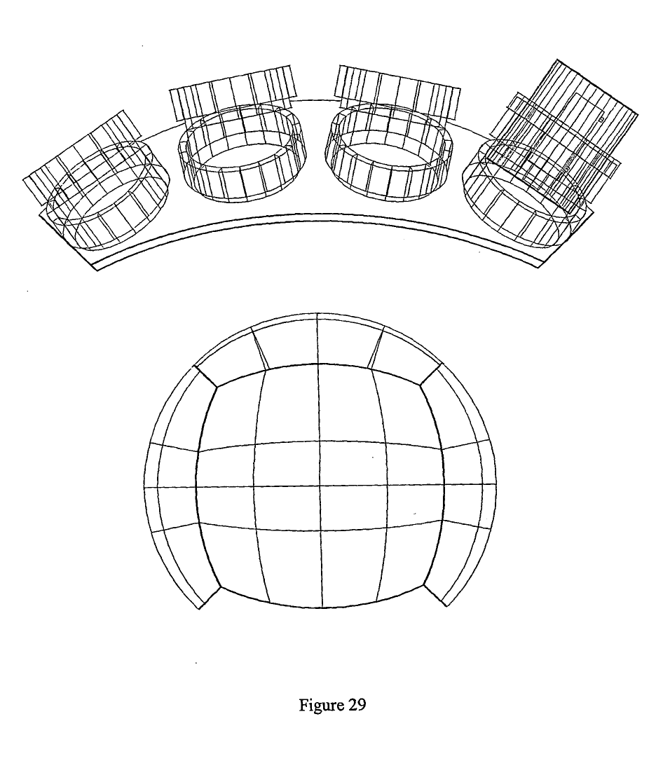

FIGS. 28 and 29 illustrate the advantages of combining elements that utilize the teachings of this. invention. The visual system illustrated is a direct projection onto a back projection screen that is viewed from the concave side. It has a 360° field-of-view in the horizontal plane and a +90°, −45° field-of-view in the vertical plane. FIG. 28 illustrates the modular components of the projector support structure. The spherical structure is divided into 5 identical elements based on a {4,3} spherical tessellation. Each element is in turn further divided into cells that will support a 3×4 array of identical projectors in such a manner to project onto a spherical back projection screen. The spherical back projection screen illustrated in FIG. 29 is subdivided in the same manner as the support structure. This thus combines the efficiencies of the cell subdivision discussed earlier. A 3×4 cell subdivision illustrates the ability of the system to take maximum advantage of the rectangular nature of existing cathode ray tube or liquid crystal display device technology. Thus, there is no loss of image area due to edge matching on a spherical surface.

1. Visual display apparatus which is generally spherical in form and which has a uniform channel edge match, seamless over-all uniform appearance to the viewer, the visual display apparatus comprising like display elements defining diamond shapes.

2. Visual display apparatus according to claim 1 in which the main display elements are in the pattern of diamond shapes, and in which the pattern of diamond shapes define rhombus elements with edges of approximately equal length, the rhombus elements forming a substantially uniform over-all pattern of generally like display elements where the rhombus elements preserve a uniform match of rows and columns of display elements between the main display areas of adjacent diamond shapes.

3. Visual display apparatus according to claim 1 in which the pattern of diamond shapes is divided into unequal numbers of rows and columns of substantial uniform quadrilateral elements, and in which the substantially uniform quadrilateral elements preserve a uniform match of rows and columns of display elements between the main display areas of adjacent diamond shapes.

4. Visual display device according to claim 1 and comprising multiple projectors of the same type having diamond shaped image planes arranged in the manner described in claim 1.

5. Visual display apparatus according to claim 1 and comprising multiple projectors placed in such a way as to project images on to a front projection screen so that in the case of an active matrix display little or no distortion mapping is required, and in the case of a fixed matrix display little or no pixel loss will occur.

6. Visual display apparatus according to claim 1 and comprising multiple projectors placed in such a way as to project images onto a back projection screen so that in the case of an active matrix display little or no distortion mapping is required, and in the case of a fixed matrix display, little or no pixel loss will occur.

7. Visual display apparatus according to claim 1 and comprising a fixed matrix emissive surface in which the pixel elements of the same type are arranged in diamond shaped patterns as described in claim 1 and so are arranged as to appear seamless and as a uniform display.

8. Visual display apparatus according to claim 1 and comprising means for reshaping rectangular formatted images into diamond formatted images that are projected in diamond shaped patterns as described in claim 1, and using anamorphic lenses, holographic lenses, micro lenses, and optical fibre transfer device, or a direct mapping device.

9. A method of tessellating a surface into a family of modular elements comprised of diamond shaped areas.

10. A method according to claim 9 in which the diamond shaped areas are approximately equal in size to each other.

11. A method according to claim 9 in which the family of tessellation follow a {p,q+}b,c symmetry group
Where: p=the shape of spherical polygon of the parent, ie. 3 is a spherical triangle.
And: q=the number of polygons arranged around the vertex of the spherical polygon.
And: b and c are counters along the edges of further triangular subdivisions of the parent spherical polygon following a path from one vertex to an adjacent vertex.
And: The number of subdivisions of the parent spherical polygon equals its frequency.
Where: Frequency (v)=b+c

12. A method according to claim 11 where the family of spherical tessellations is divided into Classes
Where:
Class I: b>0 and c=0 or b=0 and c>0
Class II: b=c
Class III: b>c or c>b and the lesser≠0 an enantiomorphic condition exists where the b and c counters are exchanged.
